(19) United States
(12) Patent Application Publication
(10) Pub. No.: US 2017/0168994 A1
(43) Pub. Date: Jun. 15, 2017

(54) Method And Apparatus For Facilitating Visual Presentations

(71) Applicants: Martin D. Carroll, Watchung, NJ (US); Michael J. Coss, Bridgewater, NJ (US); Katherine H. Guo, Scotch Plains, NJ (US); Ilija Hadzic, Millington, NJ (US); Hans C. Woithe, Raritan, NJ (US)

(72) Inventors: Martin D. Carroll, Watchung, NJ (US); Michael J. Coss, Bridgewater, NJ (US); Katherine H. Guo, Scotch Plains, NJ (US); Ilija Hadzic, Millington, NJ (US); Hans C. Woithe, Raritan, NJ (US)

(73) Assignee: Alcatel-Lucent USA Inc., Murray Hill, NJ (US)

(21) Appl. No.: 14/966,230

(22) Filed: Dec. 11, 2015

(51) Int. Cl. G06F 17/21; G06F 17/30

(52) U.S. Cl. CPC G06F 17/212; G06F 17/30011

(57) ABSTRACT

A manner of facilitating document presentation that may be used to advantage, for example, by a presenter in a meeting room or auditorium setting. A document-presentation system includes a control server that receives a document-presentation indication, for example from a presenter device or another apparatus in a meeting room or associated with a meeting. The control server communicates with the presenter, or user, and determines the document or documents to be presented and a location from which they may be obtained. The control server then sends a presentation notice to a selected render server, which downloads and renders the document. The render server renders the document to a frame buffer in local memory, encodes the pixels read from the frame buffer, and streams the encoded pixels to an adapted display device in a selected location. The render server communicates with the user via the presenter device to start, control, and terminate the presentation.

### TECHNICAL FIELD

This disclosure relates generally to communication networks, and in particular to systems, apparatus, and methods for efficiently facilitating visual presentations via a communication network.

### DESCRIPTION OF RELATED ART

The following abbreviations are herewith expanded, at least some of which are referred to within the following description of the state-of-the-art and the present invention.

API Application Program Interface

HTTP Hypertext Transfer Protocol

IP Internet Protocol

RTP Real-time Transport Protocol

TCP Transmission Control Protocol

Presentations using visual aids are common in business and other settings. In a typical situation, a presenter gives a talk to a group while referring to documents that have been displayed on a wall or screen using a projector. The projector in turn is usually connected to a laptop computer or similar device. The laptop in this scenario has a memory that stores the document. In some cases the image will not be “projected” but instead displayed on a display device driven in similar fashion to a computer screen or separate monitor.

Some documents are produced or stored as word-processing documents from one of a number of popular word-processing applications. The image displayed is similar or identical to the image that could otherwise (and may) be displayed in the laptop screen. In addition to word processing documents, presenters may also display spreadsheets, graphics files, or multimedia files. Such files each typically have their own application for generation and display. As used herein, the word “document” is used for convenience to include all of these types of files, and any similar images that may be used in a presentation. Documents may include both text and graphics, either still or animated. Documents may have several pages, or separate display images stored in the same file. A presenter may use one or more documents in a given presentation.

While documents displayed in this fashion represent in many way an improvement over older methods such as printed static displays and physical slides for use in a slide projector, there remains a need for improving the manner in which electronically-stored documents may be displayed in a presentation or similar setting.

### SUMMARY

Disclosed herein is a manner of facilitating document presentation that may be used to advantage, for example, by a presenter in a meeting room or auditorium setting. In one aspect, a document-presentation system includes a control server, a document-presentation database, and at least one render server. The document-presentation system may in some embodiments communicate with a presenter device through execution of stored program instructions on an intermediary device configured to act as a chat peer in a chat session. The presenter device may be, for example, a smart phone or tablet.

In another aspect, a method of document presentation includes receiving a document-presentation indication in a control server, determining the identity of at least one available display device, receiving an indication of at least one document to be presented, selecting at least one render server, and sending a presentation notice to the at least one render server.

In yet another aspect, a method of document presentation includes receiving a presentation notice in a render server, downloading a document associated with the presentation notice, rendering the document associated with the presentation notice, establishing a communication session between the render server and at least one display device associated with the presentation notice, and streaming the rendered document.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE SEVERAL VIEWS OF THE DRAWINGS

FIG. 1 is a schematic block diagram illustrating a document-presentation system in accordance with an embodiment of the present invention;

FIG. 2 is a simplified functional block diagram illustrating a document-presentation control server in accordance with an embodiment of the present invention;

FIG. 3 is a simplified functional block diagram illustrating a document-presentation render server in accordance with an embodiment of the present invention;

FIG. 4 is a simplified functional block diagram illustrating a presenter device in accordance with an embodiment of the present invention;

FIG. 5 is a flow diagram illustrating a method of presenting a document according to an embodiment of the present invention; and

FIG. 6 is a flow diagram illustrating a method of presenting a document according to an embodiment of the present invention.

### DETAILED DESCRIPTION

The present disclosure is directed to a manner of facilitating a visual presentation, for example one presented in a conference or other meeting room. In a currently familiar and typical setting, a presenter arrives at a meeting location with a laptop having the documents or other visual aids stored on it or on an external memory device, for example a flash drive. The meeting room is equipped with a display screen and a projector to which the laptop is attached by a cable.

These arrangements are relatively convenient in comparison to those available two or three decades ago, but still require that a presenter bring some type of computer having the presentation materials and a program for displaying them. In some cases they must also bring a projector and connecting cable if the meeting host does not provide them or if the availability of capable equipment is uncertain. In some instances unfamiliar equipment may take substantial additional time to set up, and even require the assistance of an IT employee who has experience with it.

Of course, certain advantages may obtain for employees within their own facility, or at least traveling from one of their company's facilities to another. But these advantages may not be a certainty in all circumstances and may be partially or generally unavailable to visitors.

Described herein are a system, apparatus, and method for facilitating visual presentations that it is hoped will alleviate some or all of these disadvantages. In some implementations, a presenter needs only a smartphone, tablet, or similar device.

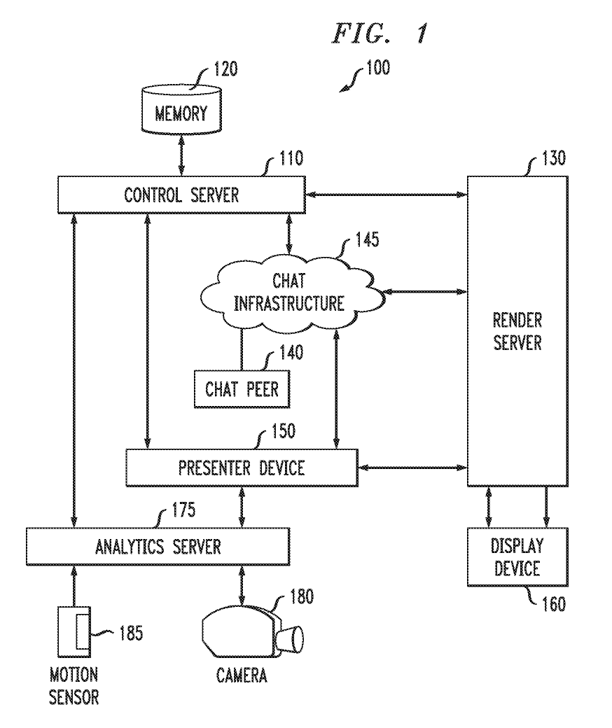

FIG. 1 is a schematic block diagram illustrating a document-presentation system 100 in accordance with an embodiment of the present invention. In this embodiment, document-presentation system 100 includes a control server 110 that is configured to manage the storage, retrieval, and display of documents, for example those which may be used in a presentation such as those described above. Control server 110 is in communication with memory device 120, which in this embodiment may be used to store various data and program instructions.

In the embodiment of FIG. 1, document-display system 100 also includes a render server 130 configured to stream documents for visual display as directed by control server 110. Shown in FIG. 1 is a single display device 160 although in a preferred embodiment there could be more than one. Render server may also, in a preferred embodiment, receive display commands from presenter device 150. In some implementations there may be more than one presenter device in communication with render server 130, although such a configuration is not shown in FIG. 1. By the same token, there may be more than one render server available in a given implementation (also not shown).

In the embodiment of FIG. 1, document-display system 100 operates in an environment with a chat peer 140. Chat peer 140 is optional but where present includes apparatus configured with program instructions to facilitate communication between presenter device 150 and control server 110 or the render server 130. Chat peer 140 operates within or at least in communication with a chat infrastructure 145, which also includes the infrastructure necessary to ensure proper chat-message and command delivery. Users preferring to use chat peer 140 to interact with the control server or render server may be permitted to enter natural-language commands or queries, for example “start presentation”, “stop presentation”, or “next page”, which presenter device 150 sends to the chat peer 140. The chat peer 140 receives and interprets these simple sentences, interactively clarifying their meaning when necessary, and sends control messages to the control server 110 or render server 130 accordingly. Communications from the control server 110 to the presenter device 150 may be converted by chat peer 140 to a more natural language for sending to the presenter device 110, where they may be presented to the user. Note again, however, that in some implementations the presenter device 150 may communicate directly with the control server 110 or render server 130, either in addition to or instead of via chat peer 140. The chat peer 140 interprets and translates messages and commands for use by the recipient node of the presentation system. As an example, many existing chat systems use XMPP, Jabber, or the like that could be used for adding the chat peer.

Also shown in FIG. 1 is display device 160. Display device 160 may be for example a projector, a television monitor, a computer screen, or any properly-configured visual-display device that has access to a communication network such as the Internet. In many implementations, display device 160 communicates over the Internet via an access network through one or more gateway devices (not shown). Note that while only one display device depicted in FIG. 1, in other implementations there could be any number. Also shown in FIG. 1 is a sensing system 170, which is optional, but may be advantageous in some implementations. Sensing system 170 may be located, for example, in a conference room or auditorium. In this embodiment, sensing system 170 includes a motion analytics server 175 for analyzing activity detected, in this embodiment, by camera 180 or motion sensor 185. Sensing system 170 in this configuration selectively activates the presentation system, or certain specific functions of it, when either any either any motion or motion having certain characteristics is detected.

In just one example, motion detected by motion detector 185 may activate camera 180, which then provides video to analytics server 175. Analytics server 175 may then in turn analyze the captured video for indications that a user may be interested in using display device 160. In that case, server 175 may then activate display of an instruction screen on display device 160 or on presenter device 150 if communication is established. It may also notify control server 110 of the potential presentation and provide the identity of any known presenter devices at that location. Note that motion analytics server 175 does not have to be in the same physical location as camera 180 and motion sensor 185, and may even be located in a distant facility and connected, for example, over a communication network. In either case motion analytics server 170 may provide analysis for a number of potential presentation locations.

The components of FIG. 1 use various communication protocols for communicating with each other. In the embodiment of FIG. 1, render server 130 uses streaming video over UDP +RTP to transmit a visual representation of the actual document or other image being presented. The document may be sent, for example, as streamed video according to the MPEG-4 H.264 standard to any display device having an H.264 decoder. In this embodiment, TCP may be used to transport control messages between the render server 130 and display device 160.

In this embodiment, render server 130 also communicates with presenter device 150 and control server 110 using TCP or a simple messaging protocol. The control server 110 may transmit documents to the render server 130 or provide an address where the document may be accessed and downloaded. Control server 110 may also provide to render server 130 information about the presenter, or more specifically about the presenter device that is associated with a document or documents. Render server 130 may also use TCP for communicating with the presenter device 150, from which it may receive presentation control messages.

In the embodiment of FIG. 1, control server may, for example, use a language-specific API to communicate with a database in the memory device 120. ReSTful HTTP may be used for communicating between the control server 110 and both the chat peer 140 and the presenter device 150 directly. Of course, different protocols than those mentioned above may be used in other implementations; and some of the system components may be able to use multiple protocols to accommodate differing environments.

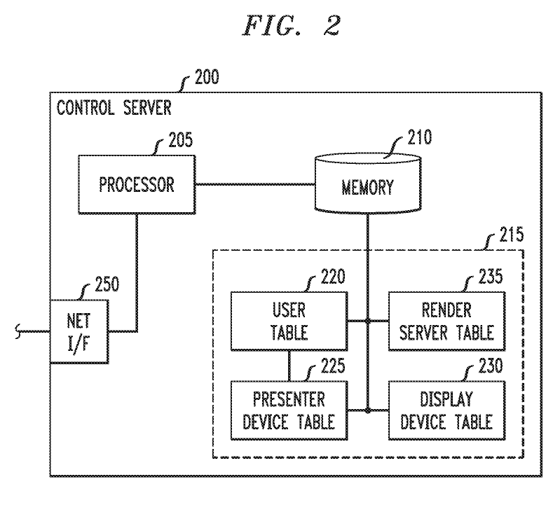

FIG. 2 is a simplified block diagram illustrating a document-presentation control server 200 in accordance with an embodiment of the present invention. In this embodiment, control server 200 includes a processor 205 and a memory device 210. Memory device 210 in this embodiment is a physical storage device that may in some cases operate according to stored program instructions. In any case, memory 210 is non-transitory in the sense of not being merely a propagating signal. Memory 210 is used for storing data as well as stored program instructions for execution by processor 205. Network interface 250 allows control server 200 to communicate with other components over a communications network such as the Internet.

In this embodiment, memory 210 comprises a presentation database 215 for storing information regarding presentation-system components and users. Information regarding components may include, for example, addresses through which they may be accessed. A table of users 220 may also be present, and if so may contain contact information, preferences, and where applicable system privileges and authentication information. Similarly, a table of presenter devices 225 may also be present and include similar information related to respective presenter devices. The use of a presenter device table acknowledges that a given user may employ more than one presenter device, and that a given presenter device may be available for use by more than one user. Naturally, where both a user table and a presenter device table are present, they should be mapped to each other as applicable.

In this embodiment, the presentation database 215 also includes a table of configured display devices 230. As used herein, a configured display device is one that is usable by the presentation system. A network interface of some kind is required, and some ability to respond to commands received over the network. A configured display device is preferably able to send information to other components, for example to confirm that it currently available for use and booted up as necessary. Depending on the implementation, a table of render servers 235 may also be present.

In some embodiments, the table of adapted display devices may contain, for example, the device's physical location and whether or not it is addressable for capable of receiving inbound connections. For such devices, the display device table preferably includes the necessary IP address and port number. Other display devices may require some other way of establishing a communication session. The configured display device table may also include the identity of an owner or operator of the device and any limitations on its use for document presentation by the system.

Note that while the presentation database 215 is illustrated in FIG. 2 as co-resident with control server processor 205, this is not necessarily the case. By the same token, a render server, described below, or a chat peer may in some implementations (not shown in FIG. 2) may be co-resident with control server processor 205 and also use the same memory device 210.

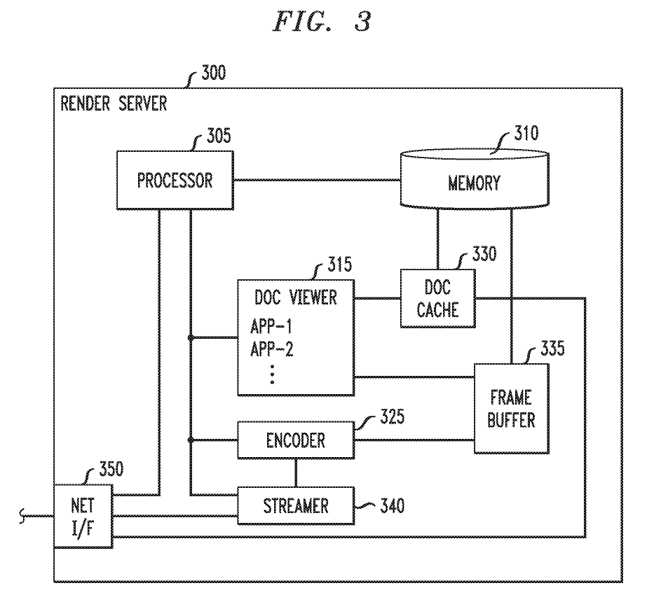

FIG. 3 is a simplified block diagram illustrating a document-presentation render server 300 in accordance with an embodiment of the present invention. In this embodiment, render server 300 includes a processor 305 and a memory device 310. Memory device 310 in this embodiment is a physical storage device that may in some cases operate according to stored program instructions. In any case, memory 310 is non-transitory in the sense of not being merely a propagating signal. Memory 310 is used for storing, among other things, data as well as stored program instructions for execution by processor 305. A separately illustrated document cache 330 stores documents for immediate and future use. Network interface 350 allows render server 300 to communicate with other components over a communications network such as the Internet, for example to receive documents for rendering. The network interface 350 may also receive control messages that indicate a control event such as advance slides, go back, start or stop video, and so forth. These control events are then provided to the document viewer where the application rendering the document makes the appropriate change.

In the embodiment of FIG. 3, render server includes a document-viewer module 315 that typically includes a number of applications (not separately shown) for viewing documents of different types, for example word processing files, graphics files, and spreadsheets. Preferably, the types of documents render server 300 is configured to view is recorded in the presentation system database and accessible to the control server for use in selecting a render server for a given presentation event. The render server 300 launches the appropriate application, that is, one that can interpret the document. The appropriate application may then interpret and render the document, that is, produce pixels for producing a representation of the document on a display. Initially, however, the rendered pixels may be stored in off-screen frame buffer 320. Note that frame buffer 320 may, for example, be part of the main memory or in a dedicated portion of a video card.

To stream a document, the render server 300 redirects the rendered pixels to an encoder 325. The encoder 325 then encodes the pixel-content of the frame buffer for video streamer 340, which packetizes the encoded content, and transmits the encoded content via a communication network to the display device (not shown in FIG. 3). Methods of delivering this content are known, for example see M. D, Carroll, I. Hadzic, and W. A. Katsak, 3D RENDERING IN THE CLOUD, Bell Labs Technical Journal, vol. 17 no. 2, pp. 55-66, September 2012, which is incorporated herein by reference. Note an important advantage of a presentation system having a render server configured for example as in FIG. 3. Although the render server may use many different applications to render documents and produce a pixel image, this pixel image is all that any given display device has to understand. As new viewer applications become available or are updated, only the render server has to be modified. The many display devices expected for use with the presentation system do not have to be changed.

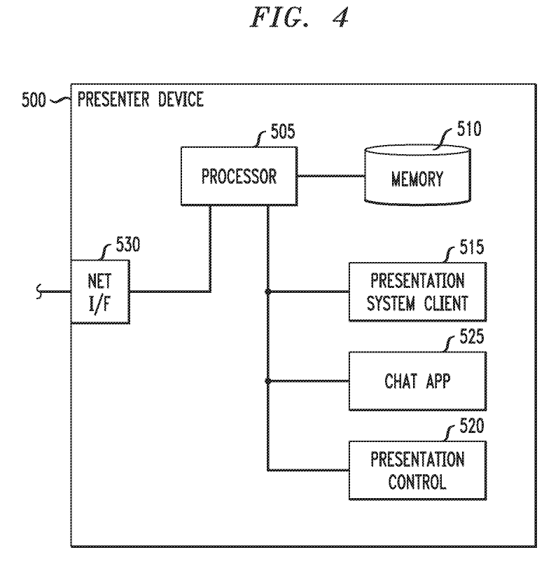

FIG. 4 is a simplified block diagram illustrating a presenter device 500 in accordance with an embodiment of the present invention. In this embodiment, presenter device 500 includes a processor 505 and a memory device 510. Memory device 510 in this embodiment is a physical storage device that may in some cases operate according to stored program instructions. In any case, memory 510 is non-transitory in the sense of not being merely a propagating signal. Memory 510 is used for storing, among other things, data such as a table (not separately shown) of managed devices as well as stored program instructions for execution by processor 505.

In the embodiment of FIG. 4, presenter device 500 also includes a document-presentation system client application 515 that facilitates the communication session with a control server (see, for example control server 110 in FIG. 1). This application 515 will typically be downloaded and installed on the presenter device before the presentation begins, but this is expected to be a relatively rapid process in most implementations. Of course, once installed the client application 515 is available for future sessions. Importantly, it is registered to the individual presenter device and is therefore not necessarily tied to a single presentation location. In many cases, the client application will be installed on a presenter's smartphone. (Company or room devices dedicated to local presentations may alternately be provided.) For example, the client application 515 allows the presenter to provide the address from which the document to be presented may be obtained, or to transfer the document itself to the control server. The presenter is also preferably able to communicate with the control server to browse available display devices for use during the presentation. In addition, the presentation system client application 515, once installed, preferably enables the presenter to perform this function well in advance and for multiple locations, and to provide or update the documents for the presentation at the same time.

Note, however, that in an alternate embodiment (not shown), the presenter device does not have an installed client application, but may instead may, for example, use a web interface. In some implementations the user may be directed to a website, in others a web page may be pushed to the presenter device (such as the user's mobile phone). In such cases the web page may emulate the user-interface of an actual client application using for example Javascript and HTML5 (presuming the device includes an HTML-capable browser).

In the embodiment of FIG. 4, also installed on the presenter device 500 is a presentation control interface 520 configured to communicate with a render server to effect the actual presentation. In some instances, this interface may be part of the client application 515. The presentation control interface 520 may, for example, include standard commands such as “next page”, “previous page”, and so on displayed as icons on the presenter device for use in manipulating the presentation document display.

In the embodiment of FIG. 4, presenter device 500 includes a chat application 525. The chat application 525 may not be present in all implementations but it is presently preferred. Chat application 525 configures presenter device 500 to engage in a chat session with a chat peer (see for example, chat peer 140 in FIG. 1.)

Finally, in the embodiment of FIG. 4, presenter device 500 includes a network interface 530 for facilitating access to one or more networks. A typical smartphone for example, enables access to short-range wireless access points as well as to a base station of a mobile network. Also available may be access to a local LAN or similar network.

FIGS. 1 through 4 illustrate selected components of exemplary configurations of the document presentation system and apparatus, and some variations are described above. Other variations are possible without departing from the claims of the invention as there recited. In some of these embodiments, illustrated components may be integrated with each other or divided into subcomponents. There will often be additional components in the illustrated devices and in some cases less. The illustrated components may also perform other functions in addition to those described above.

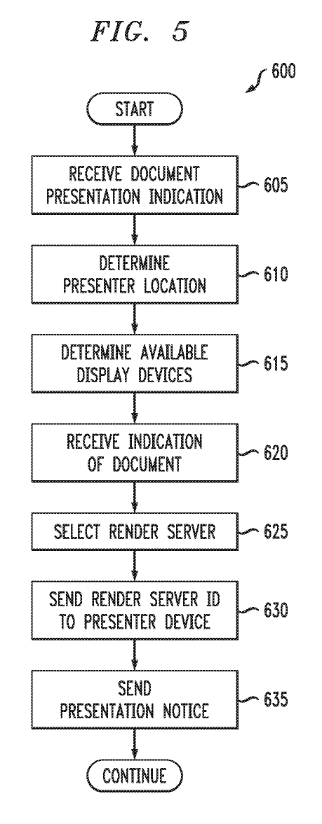

FIG. 5 is a flow diagram illustrating a method 600 of presenting a document according to an embodiment of the present invention. At START, it is presumed that the required components are available and configured to operate at least according to this embodiment. The process then begins with receiving (step 605) a document-presentation indication in a presentation control server, for example presentation control server 110 shown in FIG. 1.

The document-presentation indication may originate, for example, from a user interacting with a website associated with the control server. In a preferred embodiment, established presentation locations such as conference rooms are equipped with projection equipment that, when activated, display a URL for the presentation website or even a QR code that can be scanned for access to the presentation system. The URL or QR code preferably includes a session identifier so that when a user visits a URL-indicated website or scans a QR code, the presentation system may infer some information, for example the user's current location. In other instances, the user may simply be aware of the presentation website and access it without being prompted.

In one embodiment (see, for example, FIG. 1), a presentation location may be equipped with detection equipment such as motions sensors or video cameras, and these may be coupled with a detected-motion analysis system. When a user enters the location, a prompt of some kind may be activated (such as a QR code). In some implementations this may be locally generated, while in others a presentation-system control server may be notified. In either case, the prompt may, for example, be displayed using the same medium as would be used for the document presentation if the user responds to the prompt. In another embodiment (not shown) a user's presence may be detected by scanning for MAC addresses of the phones or other devices often carried by users and that they have registered with the system. The MAC address of, for example, WiFi, Bluetooth, or a cellular interface of the user's device may be used.

Returning to the embodiment of FIG. 5, when the control server receives a document-presentation indication, it determines (step 610) a presentation location. In many but not all cases, this will be the same as the presenter's location. So in some instances this determination is made when a presenter activates the system, while in others some type of interaction with the user will be required to determine the desired location.

In this embodiment, when the control server determines the presentation location, it then determines (step 615) the display device or devices that are available in that location. This determination may be performed by reference to the database with a table of properly configured devices and their locations or by a query to the presenter. Note that in this embodiment, it is presumed that there is display equipment available in the location and that it is configured to participate in network communications. If there are a number of available devices at the location, the presenter may be queried as to which one or more of them are to be used. The presenter may also be given the opportunity to specify devices that are not yet known to the presentation system.

In the embodiment of FIG. 5, the control server then receives (step 620) an indication of the document to be presented. This indication may be in the form of the document itself, for example uploaded by the presenter or sent in an email, or as a URL or other link indicating where the document is located. In some embodiments, documents may be loaded into a memory device associated with or accessible to the control server in advance of the presentation in order to streamline the process (not separately shown).

In any event, in this embodiment, the control server then selects (step 625) a render server (see, for example, render server 130 shown in FIG. 1). The render server may be selected, for example, by reference to a database assessable to the control server (see, for example, database 215 shown in FIG. 2). The selection may be made on availability, the type of document to be displayed, or geographic location, or based on other factors. These other factors may include, for example and not by way of limitation, the servers' past, current, and predicted resource (cpu, memory, network, etc.) utilizations. The identity of the selected server may, as shown here, be sent (step 630) to the presenter device.

In the embodiment of FIG. 5, when a render server has been selected, the control server then sends (step 635) a presentation notice to the selected render server. The presentation notice includes preferably a location address (such as a URL) where the document may be obtained. Alternately, the control server sends the document to the selected render server. The presentation notice preferably also includes the identity of at least one display device where the document is to be displayed and the identity of the presenter. Note that the presentation notice may in some implementations be a series of messages sent to the render server. If the document is to be displayed at a later time, the time of display may also be indicated.

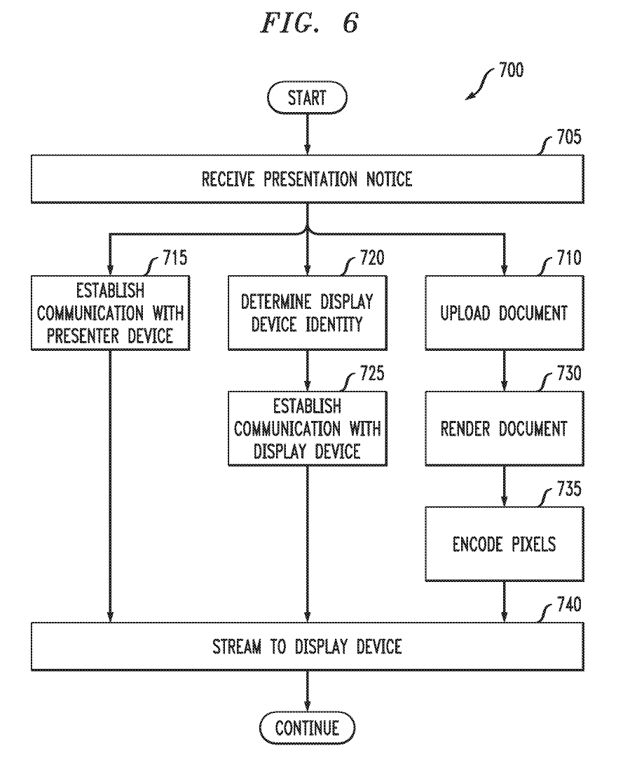

The process then continues with the control server awaiting further indications from the presenter, for example, to terminate the display or to display a different document. The selected render server facilitates the display of the document indicated, for example according the process of FIG. 6.

FIG. 6 is a flow diagram illustrating a method 700 of presenting a document according to an embodiment of the present invention. Again, at START it is presumed that the required components are available and configured to operate at least according to this embodiment. The process of FIG. 6 then begins when the render server receives a presentation notice (step 705), in this case from the control server. As mentioned above, the presentation notice includes at least the document to be displayed or, preferably, a location from which the document may be obtained. The render server then downloads (step 710) the document.

In a preferred embodiment, the render server uploads the document (step 710) into a storage location in the render server's file system. The storage location may be local, that is, associated with this particular render server, or may be in a network accessible location so that it is available to other render servers if and when needed.

In the embodiment of FIG. 6, the render server establishes (step 715) a communication session with a presenter device. As noted above the document may have multiple pages, as is normal for most presentations, and the communication session enables the presenter to communicate directly with the render server in order to go to the next desired page. In presentations involving multiple documents, the presenter may also be able to switch back and forth between the documents. Note that in an alternate embodiment (not shown), the presenter communicates only with the control server, which in turn passes commands to the render server.

In this embodiment, the render server also determines (step 720) the identity of at least one available display device and establishes (step 725) a communication session with the display device or devices. This determination may, for example, be made by reference to the presentation notice from the control server or from a communication from the presenter device. When the communication session is established, the existence and operation of the display device is in effect confirmed and the device may begin a boot-up cycle if necessary (not separately shown).

In the embodiment of FIG. 6, the render server renders (step 730) the document once it has been downloaded. Rendering the document includes selecting an appropriate viewer, for example a PDF file reader, and using the viewer to create image pixels and (preferably) storing them in a frame buffer. In some implementations there may be multiple frame buffers available and, if so, a separate one may be used for a “non-document” display that may be displayed either when a presentation document is not yet available or at the discretion of the presenter at certain points of the presentation. The non-document may also be referred to as an “interlude document”, which can be displayed whenever it is desirable to do so. An example might be a company logo or user instructions, for example a website address or a QR code that can be scanned to reach a website. The render server then may switch between the contents of different frame buffers to switch between displaying the non-document and the document itself. The multiple frame buffers may also be used in similar fashion to switch between multiple presentation documents.

In the embodiment of FIG. 6, the render server then encodes (step 735) the document (or non-document) and streams it (step 740) by directing the encoded pixels to a streamer, which packetizes and transmits those pixels to the display. The streamed document is then displayed (not shown).

The process of FIG. 6 then continues with responding to additional commands such as switching to a different page of the document, switching to a different document, or terminating the session. Note that when the session finishes, the documents themselves may be deleted immediately or be retained for future presentations. If the documents are retained, some retention policy is desirable to ensure that old and unused documents do not remain indefinitely.

Note that the sequences of operation illustrated in FIGS. 5 and 6 represent exemplary embodiments; some variation is possible within the spirit of the invention. For example, additional operations may be added to those shown in FIGS. 5 and 6, and in some implementations one or more of the illustrated operations may be omitted. In addition, the operations of the method may be performed in any logically-consistent order unless a definite sequence is required in a particular embodiment.

In this fashion a presenter may easily and efficiently handle the visual document display portion of their presentation and, in most cases, provide for multiple display locations without having to establish multiple types of sessions for document display.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

What is claimed is:

1. A method of document presentation, comprising:
receiving a document-presentation indication in a control server;
receiving an indication of at least one document to be presented;
selecting at least one render server; and
sending a presentation notice to the at least one render server.

2. The document-presentation method of claim 1, further comprising determining the identity of a display device.

3. The document-presentation method of claim 2, further comprising sending the identity of the display device to the at least one render server.

4. The document-presentation method of claim 1, wherein the document presentation indication is received from a chat peer.

5. The document-presentation method of claim 1, wherein the document-presentation indication is received from a presenter device.

6. The document-presentation method of claim 1, wherein the document-presentation indication is received in an email from an email server.

7. The document-presentation method of claim 1, wherein the document-presentation indication comprises a presenter-device identifier, and further comprising determining whether the presenter device comprises a presentation client and, if it does not, making a presentation client available.

8. The document-presentation method of claim 1, wherein determining display-device availability comprises determining that the presentation indication was initiated by a user responding to a prompt screen on an available display device.

9. The document-presentation method of claim 1, wherein the presentation notice comprises an indication of the time for presenting the document.

10. The document-presentation method of claim 1, wherein the presentation notice comprises the identity of at least one display device.

11. The document-presentation method of claim 1, further comprising:
receiving a presentation notice in a render server;
downloading a document associated with the presentation notice; and
rendering the document associated with the presentation notice.

12. The document-presentation method of claim 11, further comprising:
establishing a communication session between the render server and at least one display device associated with the presentation notice; and
streaming the rendered document.

13. The document-presentation method of claim 12, further comprising receiving a presentation control message associated with display of the rendered document.

14. The document-presentation method of claim 11, further comprising establishing a communication session between the render server and a presenter device.

15. The document-presentation method of claim 11, wherein the presentation notice is associated with a plurality of documents, and further comprising rendering at least a second document.

16. The document-presentation method of claim 11, further comprising streaming an interlude document image to a display device .

17. The document-presentation method of claim 11, further comprising receiving a presentation control message in the render server.

18. The document-presentation method of claim 11, further comprising controlling the presentation by transmitting event messages from a presenter device to the render server.

19. A method of presenting a document, comprising:
detecting the presence of a user in a presentation location;
sending a presence notification to a control server;
selecting a render server;
sending a prompt request from the control server to the render server;
receiving the prompt request in a render server;
generating a prompt document by the render server; and
streaming the prompt document to a display device in the presentation location.

20. The document-presentation method of claim 19, wherein the prompt document comprises a scan-able code.

21. The document-presentation method of claim 19, wherein the prompt document comprises a hyperlink.

22. A system for document presentation, comprising:
a control server comprising a processor;
a memory device comprising document-presentation database accessible to the control server; and
at least one render server in communication with the control server.

23. The document-presentation system of claim 22, further comprising a chat peer apparatus.

24. The document-presentation system of claim 22, further comprising at least one display device in communication with a network interface.
